(19) United States
(12) Patent Application Publication
(10) Pub. No.: US 2008/0137688 A1
(43) Pub. Date: Jun. 12, 2008

(54) Transfer of Data Objects

(76) Inventor: Rod Walsh, Tampere (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/631,235

(22) PCT Filed: Jun. 30, 2004
(86) PCT No.: PCT/IB04/02172

§ 371 Date: Dec. 29, 2006

(51) Int. Cl. H04J 3/00

(52) U.S. Cl. 370/498

(57) ABSTRACT

A method, computer program/product, system, transmitter and receiver suited for the transfer of at least one data object (50) to the receiver (101) are shown, wherein the at least one data object is associated with a respective data envelope (51) that serves for at least one of identifying, versioning and time bounding the at least one data object, the method embedding (110) the at least one data envelope and a representation of the at least one data object into a compound container object (52), and transferring (112) the compound container

object to the receiver. The at least one data object may be a metadata object that represents a description of services and/or content that can be used by the receiver, and the compound container object is furnished with a compound container envelope (53) that serves for at least one of identifying, versioning and time bounding of the compound container object.

### FIELD OF THE INVENTION

This invention relates to the transfer of at least one data object to a receiver, wherein said at least one data object is associated with a respective data envelope that serves for at least one of identifying, versioning and time bounding said at least one data object.

### BACKGROUND OF THE INVENTION

Digital Content is delivered to users, for instance fixed or mobile terminals in a communications system, by either streaming or download of discrete data objects, for instance files. This digital content may for instance be represented by movies, music or textual information.

A user, and a user device, in general first have to discover content in order to select and obtain the content and possibly the rights to use the content. Within the Internet Engineering Task Force (IETF), the Internet Media Guides (IMG) work has defined a framework for the delivery of content descriptions, known as metadata, allowing a variety of data formats (syntaxes) and a variety of transport mechanisms, for instance the Hypertext Transfer Protocol (HTTP) fetch, or the Session Initiation Protocol (SIP) subscribe, or the File Delivery over Unidirectional Transport (FLUTE) service announcement. This framework is presented in detail in the IETF document “draft-ietf-mmusic-img-framework-07.txt” of the MMUSIC WG (Nomura, Y et. al), of Jun. 21, 2004.

The IMG framework describes a metadata envelope to provide minimal description of metadata objects, e.g. Session Description Protocol (SDP) files, so that they can be: identified, versioned and time-bounded. This enables the simple management of metadata changes, e.g. version changes, and validity/expiry, e.g. use of metadata only during the valid time and garbage collection of expired metadata.

The SA4 working group of the Third Generation Partnership Project (3GPP) has specified the metadata envelope for use with service announcements for Multimedia Broadcast/Multicast Service (MBMS) in 3GPP release 6. 3GPP will fully specify the use in combination with FLUTE. 3GPP will also enable and possibly specify the use of the metadata envelope with other delivery methods and protocols, such as HTTP retrieval of metadata in conjunction with the metadata envelope.

It may be expected that the European Telecommunication Standardisation Institute (ETSI), in the context of the Digital Video Broadcasting (DVB) system, will specify the use of metadata envelopes for Internet Protocol Device Control (IPDC) services and potentially for any broadcast-using-IP service announcement/discovery system.

A metadata envelope provides information on a metadata object to enable the management of the object in its various versions. Metadata envelopes are particularly useful in any of these cases:
where the metadata is likely to change during its useful life, so that its version number changes,
where more than one delivery session and/or transport protocol/mechanism is used for the same metadata object, e.g. both HTTP and FLUTE can be used to get the same metadata objects,
where parts of a larger body of data or metadata may change somewhat independently of others, e.g. the description of a football match may change, whilst leaving the description of the football tournament the same, such that each part needs to be distinctly identified,
where the source of metadata wishes to indicate to the receiver/client that the data has limited applicability, such that it may not be useful until a certain time, or the receiver is expected to delete or update the data after a certain time, for instance an expiry time.

Metadata envelopes can generally describe any useful part of a metadata object, e.g. size, checksum, source, associated operator logo, etc. However, it is recognised that the basic useful set of data common to most cases is:
metadata object identification, e.g. as a Uniform Resource Identifier (URI),
metadata object-version, e.g. as an integer number, and
metadata object time-validity, e.g. as a pair of “valid from” and “valid until” Normal Time Protocol (NTP) time stamps.

A metadata envelope may for instance be instantiated by binary encoding, as a protocol header field (possibly an extension header), by a textual description (e.g. an Extended Markup Language (XML) textual description) and other means.

Although there are potentially very many ways to use metadata envelopes, four cases are particularly useful and described here for illustration:
As a delivery envelope which “carries” the metadata object as “payload”. For example, the envelope could be an XML file which embeds an SDP or another XML file (representing the metadata object) within it. This case is illustrated in FIG. 1, wherein three metadata envelopes 11-1 . . . 11-3 are shown that contain embedded metadata objects 10-1 . . . 10-3, respectively. Another example is where the envelope is given in protocol header fields and the metadata is delivered as packet payload.
As an in-band associated delivery object. For example, a metadata object and its metadata envelope and further different objects are delivered as different files within the same download session, as schematically depicted for a metadata object 10 and metadata envelope 11 in FIG. 2a. In such a case, the two (metadata object and envelope) need to be associated, which can be performed by promiscuously receiving envelopes and checking for the metadata object identification to which it is associated. The two objects may also be delivered one after the other, e.g. as a series of files in order: envelope, metadata1, envelope2, metadata2, etc. This case is illustrated in FIG. 2b, wherein four objects 20-1 . . . 20-4 are received over communication channel/session 23, and wherein object 20-1 represents a metadata envelope that is associated with the metadata object contained in object 20-2. Similarly, the metadata envelope 20-3 is associated with the metadata object contained in object 20-4.
As an out-of-band associated delivery object. In contrast to the preceding case of in-band association, the envelope and metadata objects are delivered in different communications channels or sessions, as illustrated in FIG. 3. Therein, one channel or session 34-1 may deliver a stream of envelopes 31-1 and 31-2, and another channel or session 34-2 may deliver a stream of metadata objects 30-1 and 30-2. In this case, it is important to consistency-check the two objects, so that the envelope points to a specific version of the metadata object. As further illustrated in FIG. 3, both a one-way association and a mutual (two-way) association of metadata envelope and metadata object is possible.
As an event notification, as illustrated in FIG. 4. Therein, a channel or session 44 delivers metadata envelopes 40-1 . . . 40-6, and clients may check these to assess whether metadata objects have been added, changed or been removed from the body of metadata. For instance, whereas between the reception of metadata envelopes 40-1 and 40-4, no change in metadata object A occurred, between the reception of metadata envelopes 40-4 and 40-6, a change in version of metadata object A actually took place, and the receiver is thus notified that an update of metadata envelope A is required, which can be obtained from the location indicated by the pointer to A in metadata envelope 40-6. The advantage of such an event notification is that the bandwidth required for an envelope stream is generally much less than that required for the metadata objects they describe, and thus faster notification of consistency is possible within limited data rates. Delivery of metadata objects may use the same mechanism as envelopes, e.g. both by FLUTE over multicast, or different mechanisms, e.g. envelopes over FLUTE/multicast and metadata over HTTP/unicast.

A data model defines data entities and describes their relationships.

For example, a metadata model (or service description) may define the entities service, content item and delivery session, and a service may consist of one or more content items and one or more sessions. And then, for example, that content items of the service are delivered by exactly one of the delivery sessions of the service. Rights, security, associated services, bundles of services, operator logos and many other entities could be included in a metadata model too.

It is possible to build the data model into the delivery of data. For instance, the Digital Storage Media Command and Control

(DSM-CC) within the Motion Pictures Expert Group (MPEG) standard defines object carousels which deliver data objects. A certain descriptor describes containers, each of which contains one or more data objects. As such, the retrieval of one object from the container results in the retrieval of all objects from that container. As such, all the objects of a container are associated for delivery and this is used to ensure that a group of objects/entities with particular data model relationships are delivered together. However, DSM-CC relies on several different descriptors (messages) to link the objects together. DSM-CC does furthermore not cover the transfer of envelopes that identify and/or version and/or time bound data objects.

Some systems require extremely simple operations, and multiple object downloads to receive a set of envelopes and their metadata objects is undesirable. Thus it is useful to provide a single compound metadata object with all the desired objects contained in it. Thus the compound metadata object can easily be retrieved as a single message, e.g. by a single HTTP GET. However, combining the metadata objects into a single, new, compound metadata object has certain problems:
it requires a new object entity and format, e.g. a new/combined XML-schema;
it makes it difficult to identify the individual objects, which themselves may also be delivered separately, and to update a subset of the compound object: small parts of the metadata may change and so the larger a compound metadata object, the more unchanged data needs to be resent along with the changed data (and the original metadata object structure will generally be optimised to minimise this effect);
metadata objects may be referenced from several parts of a metadata model and it is important to keep the identification, and delivery-agnostic definition, separate from other objects related to the data model; and
some delivery methods/mechanisms enable grouped delivery just as effectively (e.g. File Delivery Table (FDT) grouping by FLUTE), and building a very large object will result in a larger loss-multiplier effect and thus will unnecessarily require higher reliability (QoS) from the delivery method and bearer.

### SUMMARY OF THE INVENTION

In view of the above-mentioned problems, it is thus a general object of the present invention to provide a method, a computer program, a computer program product, a system, a transmitter and a receiver for an efficient transfer of data objects.

A method is proposed for transferring at least one data object to a receiver, wherein said at least one data object is associated with a respective data envelope that serves for at least one of identifying, versioning and time bounding said at least one data object, comprising embedding said at least one data envelope and a representation of said at least one data object into a compound container object, and transferring said compound container object to said receiver.

Said receiver may be any device or instance being capable of physically and/or logically receiving data objects or representations thereof. For instance, said receiver may be a terminal in a fixed or wireless communication system, or a radio or television receiver, or a similar device. Said at least one data object may represent any form of information. For instance, said data object may represent a description of a service or content, for instance an SDP file, that can be made available to said receiver. Said data object is associated with a respective data envelope, which identifies, versions and/or time bounds said data object. If several data objects are transferred, each is associated with its own data envelope. Said identification and versioning may be represented by integer numbers. Said time bounding may be represented by validity dates, for instance by a pair of “valid from” and “valid until” dates that are related to a specific time base, for instance to NTP time stamps.

According to the method of the present invention, a representation of said at least one data object is embedded into said compound container object together with its associated data envelope, wherein said representation of said at least one data object may either be a reference or pointer to said at least one data object or said at least one data object itself. Then, if representations of several data objects are embedded into said compound container object together with their associated data envelopes, the information contained in said data envelopes may for instance be processed to determine a joint time bound for all data objects in said compound container, which may serve as a time bound for the compound container object.

Said compound container object then is transferred to said receiver, which, due to the fact that multiple data objects are combined into one compound container object, requires only the transfer of said one compound container object and thus significantly reduces transfer overhead. For instance, the transfer may then be achieved by a HTTP GET command. The embedding of both the data objects and the data envelopes allows to keep track of the identities, versions and time bounds of the single data objects contained in said compound container and thus allows to control the transfer, i.e. the compound container object then only may have to be transferred if the data envelope information associated with the data objects contained in the compound container object indicates the necessity of such a transfer. Thus according to the method of the present invention, an efficient transfer of data objects is achieved, and in particular, for the first time, a method to group a set of metadata objects and metadata envelopes for common delivery over IP-based bearers has been presented.

According to a preferred embodiment of the present invention, said at least one data object is a metadata object that represents a description of services and/or content that can be used by said receiver. Said metadata object may for instance be an SDP file.

According to a further preferred embodiment of the present invention, said at least one data object and said respective associated data envelope form a data pair, and wherein at least two of said data pairs are embedded into said compound container object. Therein, said at least two data objects be of the same or of different types.

According to a further preferred embodiment of the present invention, said representation of said at least one data object is said data object itself, or a reference to said data object. In the first case, said at least one data object is then embedded into said data envelope, whereas in the latter case, said at least one data object is only referenced by said data envelope, wherein said reference may for instance be accomplished by a pointer and may be in-band or out-of-band, i.e. referring to a data object in the same of in a different transfer channel or session with respect to the transfer channel or session said data envelope is transferred in.

According to a further preferred embodiment of the present invention, the method further comprises determining a compound container envelope that serves for at least one of identifying, versioning and time bounding of said compound container object, and transferring said compound container envelope to said receiver. Said identifying, versioning and/or time bounding of said compound container object may depend on said identifying, versioning and/or time bounding of said data objects contained in said compound container object, or may be independent of it.

According to a further preferred embodiment of the present invention, said compound container object is versioned separately from said at least one data object it contains.

According to a further preferred embodiment of the present invention, said time bounding of said compound container object at least partially depends on said time bounding of said at least one data object it contains.

According to a further preferred embodiment of the present invention, said compound container envelope and said at least one data envelope obey the same semantics and syntax. This may vastly simplify system operation.

According to a further preferred embodiment of the present invention, said compound container object obeys the Multipart Multipurpose Internet Mail Extensions format. This allows a maximum reuse of existing standards and contributes to the efficiency of the method.

According to a further preferred embodiment of the present invention, said compound container object is considered as a data object, and wherein a representation of said compound container object is embedded into a hierarchically superordinated compound container object. There may be no limit to the number of nested compound containers allowed, thus any amount of hierarchical relationship between compound containers may be permitted.

According to a further preferred embodiment of the present invention, said compound container object contains at least one object that provides information on the structure of said compound container object and/or on the data objects contained therein. Said at least one object may for instance be an index object that lists the data objects contained in said compound container. Thus, upon parsing this index object, a receiver may be able to identify the contained objects and potentially also calculate the compound container object structure, for instance when the index describes the order of the contained objects and their lengths.

According to a further preferred embodiment of the present invention, said compound container object is transferred to said user via the Hypertext Transfer Protocol and/or the File Delivery over Unidirectional Transport protocol.

According to a further preferred embodiment of the present invention, data envelopes and representations of data objects embedded into said compound container object (52) are transferred (112) to said receiver via different bearers and/or protocols. Said bearers and/or protocols may for instance be HTTP or FLUTE. One data object embedded into said compound container object then may for instance be transferred to the receiver via HTTP first, and then via FLUTE. Alternatively, a first data object embedded into said compound container object may for instance be transferred via HTTP together with said compound container object, whereas a representation of a second data object embedded into said compound container object, for instance a reference to said second data object, may be transferred via FLUTE or via both HTTP and FLUTE.

According to a further preferred embodiment of the present invention, data envelopes and representations of data objects embedded into said compound container object (52) are transferred (112) to a first receiver via a first set of bearers and/or protocols, and wherein data envelopes and representations of data objects embedded into said compound container object (52) are transferred (112) to a second receiver via a second set of bearers and/or protocols. Then, for instance, different receivers obtain the same data object over different transport channels, bearers and/or protocols. Choosing different bearers and/or protocols for the transfer of compound container objects (or parts thereof) to different receivers allows for an optimal adaptation of bearers and/or protocols to the transfer conditions between the transmitter or source of the compound container object and the respective receivers.

A computer program is further proposed with instructions operable to cause a processor to perform the above-mentioned method steps.

A computer program product is further proposed comprising a computer program with instructions operable to cause a processor to perform the above-mentioned method steps.

A system is further proposed for transferring at least one data object to a receiver, wherein said at least one data object is associated with a respective data envelope that serves for at least one of identifying, versioning and time bounding said at least one data object, comprising means arranged for embedding said at least one data envelope and a representation of said at least one data object into a compound container object, and means arranged for transferring said compound container object to said receiver.

A transmitter is further proposed for transferring at least one data object to a receiver, wherein said at least one data object is associated with a respective data envelope that serves for at least one of identifying, versioning and time bounding said at least one data object, said transmitter comprising means arranged for embedding said at least one data envelope and a representation of said at least one data object into a compound container object, and means arranged for transferring said compound container object to said receiver.

A receiver is further proposed for receiving at least one data object, wherein said at least one data object is associated with a respective data envelope that serves for at least one of identifying, versioning and time bounding said at least one data object, wherein said at least one data envelope and a representation of said at least one data object are embedded into a compound container object, and wherein said compound container object is transferred to said receiver by a transmitter, said receiver comprising means arranged for receiving said transferred compound container object, and means arranged for extracting said at least one data envelope and said representation of said at least one data object from said received compound container object.

A method is further proposed for transferring data objects to a receiver in a file carousel system, wherein all data objects of a subset of data objects out of a plurality of data objects require to be associated so that a receiver knows to receive all data objects of said subset, comprising embedding respective representations of all data objects of said subset into a compound container object, and transferring said compound container object to said receiver.

According to this method of the present invention, the association between data objects of said subset is accomplished by embedding them into a compound container object rather than using descriptors or data models, and thus represents a more efficient technique for the transfer of data objects. Said data objects may then for instance be transferred over IP.

These and other aspects of the invention will be apparent from and illustrated with reference to the embodiments described hereinafter.

### BRIEF DESCRIPTION OF THE FIGURES

In the figures show:

FIG. 1: A schematic presentation of metadata envelopes with embedded metadata envelopes according to the prior art;

FIG. 2a: a schematic presentation of a metadata envelope with an associated metadata object according to the prior art;

FIG. 2b: a schematic presentation of in-band associations between metadata envelopes and metadata objects within a single communications channel or session according to the prior art;

FIG. 3: a schematic presentation of out-of-band associations between metadata envelopes in a first communications channel or session and metadata objects in a second communications channel or session according to the prior art;

FIG. 4: a schematic presentation of event notification in an envelope channel according to the prior art;

FIG. 5a: a schematic presentation of a compound container object according to the present invention, wherein the metadata object is embedded into the metadata envelope;

FIG. 5b: a schematic presentation of a compound container object according to the present invention, wherein the metadata object and the metadata envelope are separately embedded into the compound container object;

FIG. 6a: a schematic presentation of multiple pairs of metadata objects and associated metadata envelopes in a compound container object according to the present invention;

FIG. 6b: a schematic presentation of a compound container object obeying the Multipart MIME format according to the present invention, wherein the compound container object is embedded into the compound container envelope;

FIG. 7a: a schematic presentation of a multi-layer compound container hierarchy according to the present invention;

FIG. 7b: a schematic presentation of a multi-layer compound container according to the hierarchy of FIG. 7b;

FIG. 8: a schematic presentation of a compound container with an index object according to the present invention;

FIG. 9: a schematic presentation of out-of-band associations between metadata envelopes in a first compound container object in a first communications channel and their associated metadata objects in a second compound container object in a second communications channel and a metadata object in a third communications channel;

FIG. 10: a schematic presentation of a system according to the present invention; and

FIG. 11: a flowchart of a method according to the present invention.

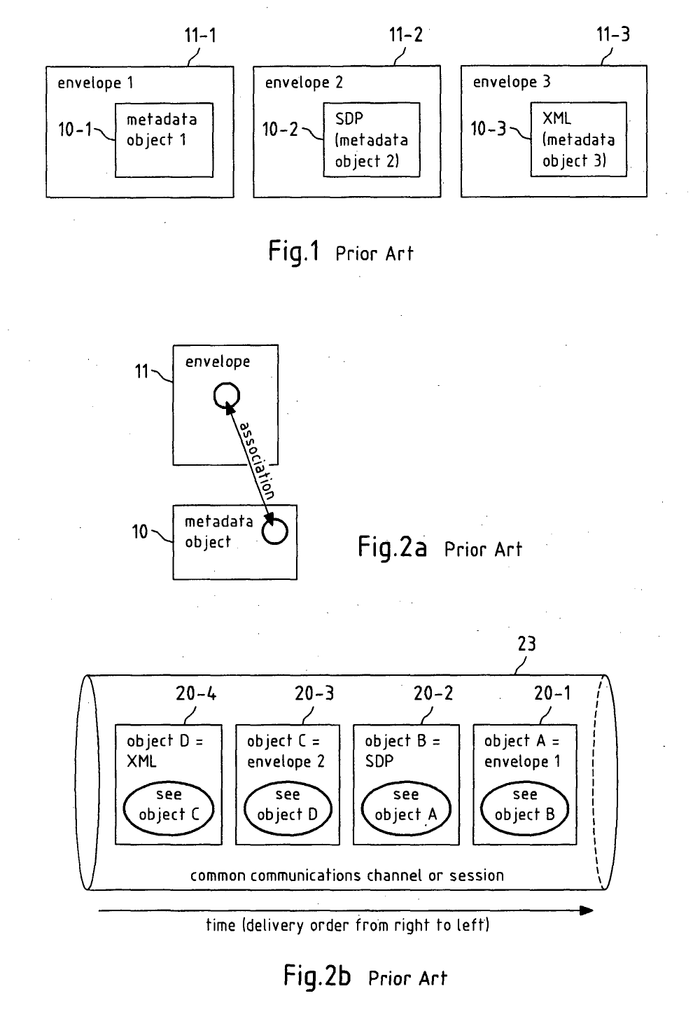

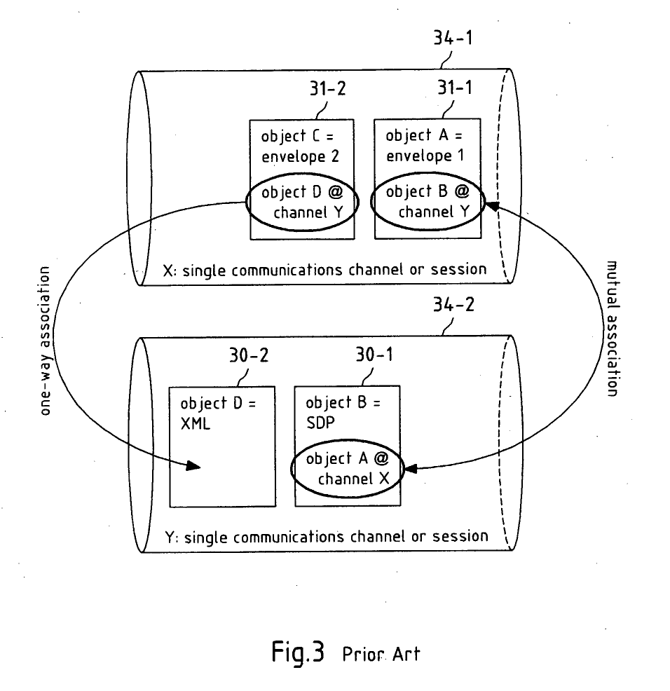

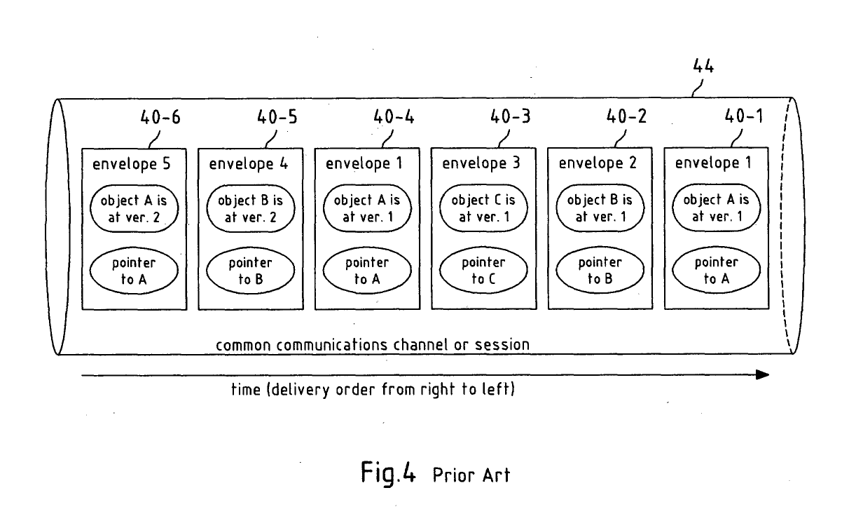

### DETAILED DESCRIPTION OF THE INVENTION

To achieve an efficient transfer of data objects, the present invention proposes to embed data objects and their associated data envelopes into a compound container object and to transfer the compound container object to a receiver. In the following, an exemplary implementation of this inventive concept will be described in the context of metadata objects that describe services or content that can be made available to a receiver. It is understood that the present invention is suited for the grouped transfer of all types of data objects and by no means shall be restricted to the transfer of metadata objects.

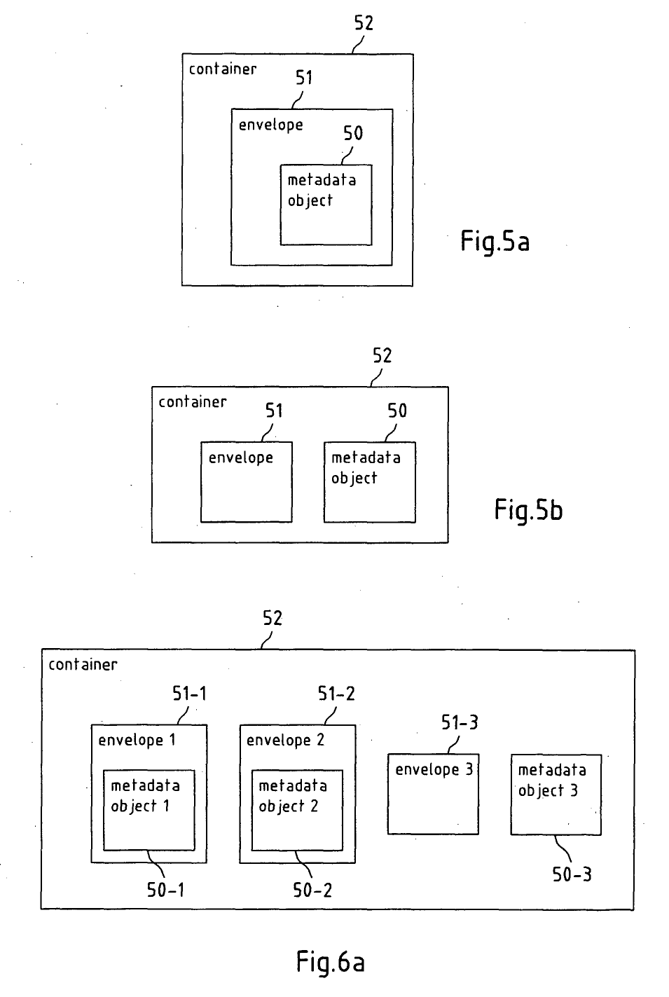

As shown in FIGS. 5a and 5b, respectively, within a compound container object 52, a metadata object 50 may itself be embedded in its metadata envelope 51 (FIG. 5a) or as a separate object in the compound container object (FIG. 5b). I.e., in illustrative syntax, “container(envelope(metadata))” and “container(envelope, metadata)” are both within the scope of this invention.

One example structure with a single metadata object would be: Cenvelope(Container(Menvelope(MetadataObject))), where Menvelope is the metadata envelope associated with the metadata object and Cenvelope is the metadata envelope associated with the compound container object.

All Cenvelope and Menvelope entities may have the same semantics and syntax, i.e. the same data field in the same format, as this simplifies system operation. However, different envelope formats, with a different use of optional fields, or with different format definitions, are within the scope of this invention, for instance the case where the Cenvelope includes a description of the compound container object's length in bytes, whereas other envelopes do not include a length field.

Compound container objects may advantageously be versioned separately from the metadata objects they contain.

It is advantageous to calculate the time validity of the compound container object as a function of the time validity, for instance in terms of “valid from” and “valid until” parameters, of the objects it contains, rather than have no relationship between the compound container object and contained objects. In particular, at least these three methods are possible for alternative deployments:
Container with any useful data: container “valid from”=the earliest “valid from” value of all the objects it contains; container “valid until”=the latest “valid until” value of all the objects it contains.
Container with only active data: container “valid from”=the latest “valid from” value of all the objects it contains; container “valid until”=the earliest “valid until” value of all the objects it contains (note, this may generally expect that every “valid to” value is later than every “valid from” value, so as to ensure that the container “valid until” value is later, in time, than its “valid from” value).
Container with only valid data: container “valid from” the earliest “valid from” value of all the objects it contains; container “valid until”=the earliest “valid until” value of all the objects it contains.

Therein, the terms “useful”, “active” and “valid” may be understood in the following fashion: “Valid” means “valid as specified”, i.e. according to time bound or subsequent update. “Active” means “in active use” (usually data would only be active while it is valid—but see “useful”). “Useful” means “any point the data is useful”, e.g., if delivered prior to the “valid from” timestamp, it is still useful even if not active; also, even after data has been updated or expired, it may be useful, if a new version has not yet been correctly received, or for archiving or history tracking.

The Container object may advantageously partition the contained objects. This may be performed by one or more of these methods (and other methods too):
List a “table of contents” of contained objects with their lengths and order they occur in the message. Thus the data point (byte number) of the start of each object may be calculated. Note, any padding or control data between objects may have to be known and taken into account, e.g. if there is a single “carriage return line feed” (CRLF) character between each object, then the number of bits or bytes this requires may have to be factored into the calculation, in this case the character set may also need to be described as a single character 7, 8, 16 or any number of bits depending on the character set it is from. Among other things, the character set sets the number of bits that define a single character. It is useful to know this information to determine at which point (in bits or bytes) the relevant data “part” occurs—for instant/random look-up without parsing all the previous parts and boundaries.
List a “table of contents” of contained objects with their position, e.g. in bytes, that they start and/or end in the message. Thus the data point (byte number) of the start of each object may be found.
Define and use a boundary delimiter, such as the text string “—boundary—” in a known character set, e.g. US ASCII. This may be defined out-of-band, e.g. in a standard, or within the container fields to allow better selection of a delimiter that will not be found in the actual contained objects—and avoid false identification of a boundary.
List a “table of contents” of contained objects with the “start of file” data as the boundary delimiter of the object, i.e. if an object starts with the data “0x0D457AE1” then this may be used as the delimiter. Note, this may generally be not a preferred solution as textual objects often start with the same text strings.

Advantageously each (envelope, object) pair is structured the same, e.g. the same envelope format is used and all metadata objects are embedded in the envelope. However, the use of different structuring may be permitted and in scope.

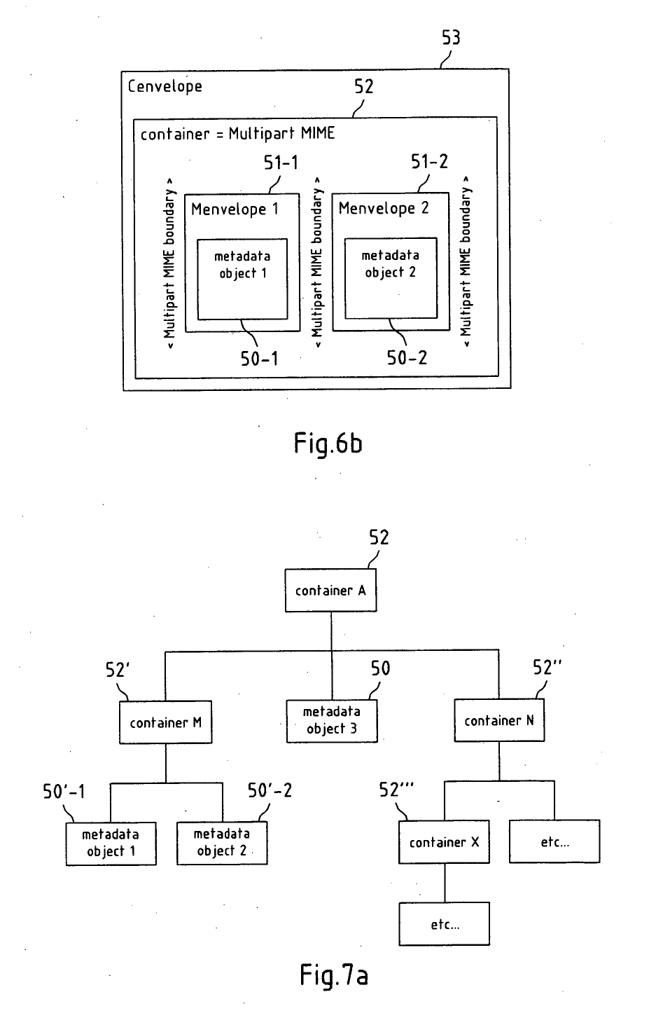

FIG. 6a schematically depicts the inclusion of multiple pairs of metadata envelopes and metadata objects (51-1 and 50-1), (51-2 and 50-2) and (51-3 and 50-3) into a compound container object 52, which enables the common delivery of multiple metadata objects along with their envelopes according to the present invention.

Multipart MIME (MMIME) provides a ready format for multiple objects. MMIME is described in detail in Request For Comments (RFC) document 2046 “Multipurpose Internet Mail Extensions (MIME) Part Two: Media Types)”. The MMIME object defines boundary delimiters in its header and inserts these between the objects it contains. Although this invention includes all Multipart MIME content types (registered by the Internet Assigned Numbers Authority (IANA) and otherwise), the “Mixed” content type may be particularly suited for this invention.

FIG. 6b schematically depicts an according compound container object 52 obeying the MMIME format, wherein the compound container object 52 contains two metadata envelopes (Menvelopes) 51-1 and 51-2 with respective embedded metadata objects 50-1 and 50-2, wherein MMIME boundaries are inserted between the Menvelopes. The compound container object 52 is further furnished with a compound container envelope (Cenvelope) 53, which describes the validity and version of the Multipart MIME object 52. As described for other objects, the MMIME object 52 may be embedded in the Cenvelope (as in FIG. 6b) or delivered as a separate (in or out of band) object.

Container objects themselves require an identifier. A Uniform Resource Identifier (URI) may be preferred for this, for instance to achieve maximum compatibility with FLUTE and HTTP. The same holds for metadata objects.

A container may be used as a type of metadata object itself. As such, it may be embedded or referenced from other “super-container” objects, just as any metadata object is. It also requires an envelope (and in this case Cenvelope_n=Menvelope_m).

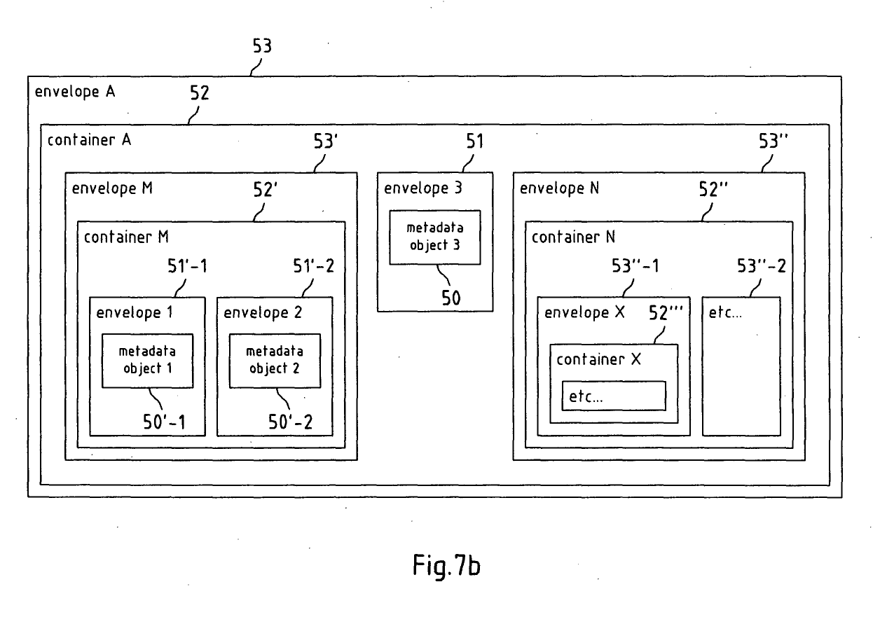

FIGS. 7a and 7b depict schematic presentations of a multi-layer compound container object hierarchy and the according multi-layer compound container object 53, respectively. For instance, as can be readily seen, container 52, furnished with envelope 53, contains envelope 53′, into which container 52′ is embedded. In this example, container 52′ is embedded in envelope 53′. Alternatively, container 52′ may only be referenced by envelope 53′.

Self recursive container hierarchy may be dangerous and may generally best be avoided. For instance, container A including container B, which itself includes container A, would lead to intimately large containers A and B. A method to allow this, and to avoid unbounded object sizes, may be to use envelope references to metadata object outside the structure.

The use of index objects may be particularly useful when the container object does not provide a listing of contained objects in its header or preamble—as it is for instance the case with MMIME. Note, MMIME is able to provide such a listing in its preamble. However, since relays and other devices are allowed to modify and delete the non-mandatory preamble, it may generally be preferred for MMIME to give this information in a contained object.

The index objects may also be used to map metadata envelopes to metadata objects, for metadata object that are not embedded and thus separate from their envelopes.

The index object may for instance use a newly defined format or an existing format. The index may identify the contained objects, their types (e.g. envelope, SDP file—or generally content/MIME type) and, potentially, their length. The FLUTE File Delivery Table (FDT) format provides these and its use is within the scope of this invention.

In general, it may be advantageous to use only a single index object per compound container object or layer of hierarchy, and to position this index object as the first object in the order of contained objects.

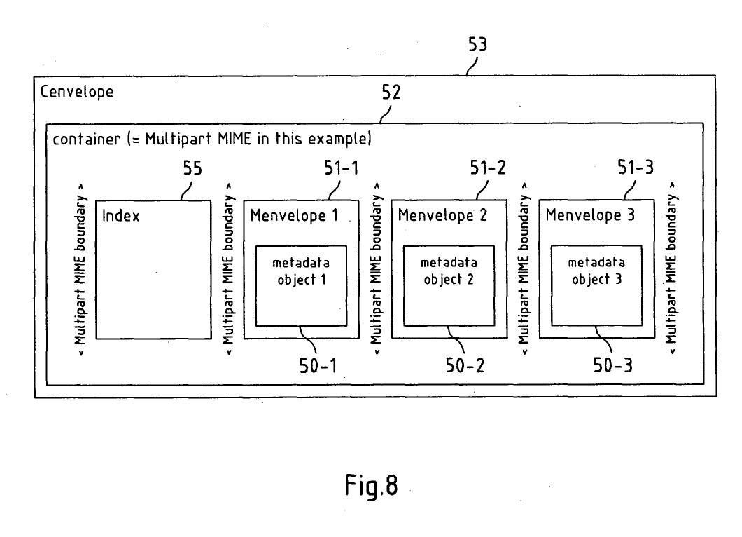

FIG. 8 depicts an according example, wherein an index object 55 is embedded into a compound container object 52 together with metadata envelopes (Menvelopes) 51-1, 51-2 and 51-3, wherein the compound container object obeys the MMIME format, so that all objects contained in the compound container object 52 are separated by MMIME boundaries. The compound container object 52 is further furnished with a compound container envelope (Cenvelope) 53.

The actual metadata object referenced, i.e. pointed to or located, may be delivered in a different container, in a different session (possibly without a container itself), using a different transport protocol, using a different bearer, over a different (hybrid) network technology, etc. For instance, a container delivered using FLUTE may contain 10 metadata envelopes, each of which points to a different metadata object URL available over HTTP. The reference may also be to another container (where nested/hierarchical containers are being used).

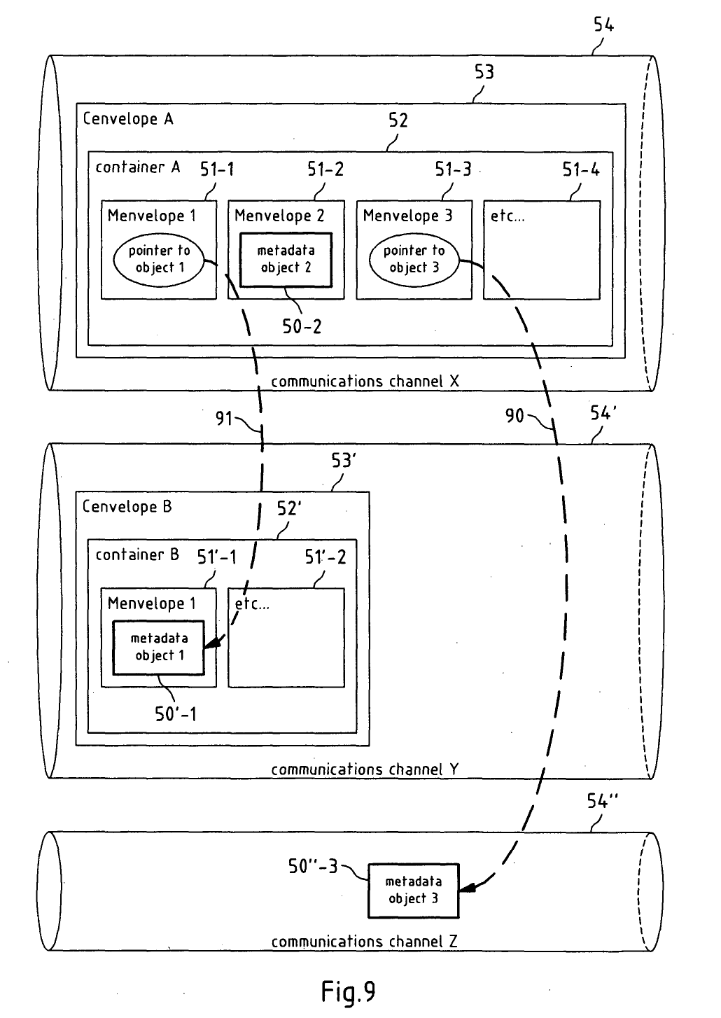

FIG. 9 schematically depicts this case with three communication channels 54, 54′ and 54″. The metadata envelopes 51-1 and 51-3 embedded into compound container 52, which is transferred by communications channel 54, reference metadata objects 50′-1 and 50″-3, respectively, wherein referenced metadata object 50′-1 is embedded into metadata envelope 51′-1 which in turn is embedded into compound container object 52′, which is transferred by communications channel 54′, and wherein referenced metadata object 50″-3 is transferred without envelope and compound container object in communications channel 54″.

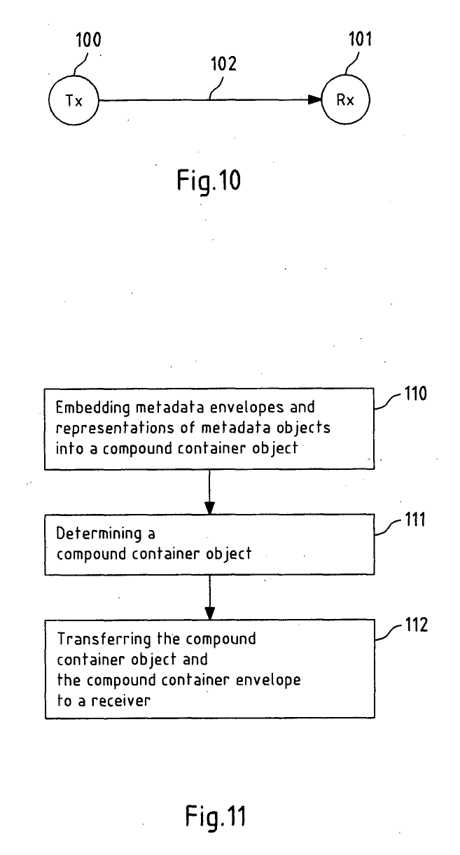

FIG. 10 schematically depicts a system according to the present invention. The system comprises a transmitter 100 and a receiver 101. Said transmitter may for instance be a content server and/or a server that provides descriptions of content that can be received by said receiver. Note that the server that provides the content and the server that provides the description of the content do not necessarily have to be the same or be co-located. Metadata objects containing this description, for instance in SDP file format, are then grouped by embedding them or references to them with their associated metadata envelopes into a container object, which then is transferred to the receiver via a communications channel 102.

FIG. 11 depicts a flowchart of a method according to the present invention. In a first step 110, metadata envelopes and representations of metadata objects are embedded into a compound container object. In a second step 111, at least partially based on said information contained in said metadata envelopes, a compound container envelope is determined. Finally, in a third step 112, the compound container object and the compound container envelope are transferred to a receiver.

The invention has been described above by means of preferred embodiments. It should be noted that there are alternative ways and variations which are obvious to a skilled person in the art and can be implemented without deviating from the scope and spirit of the appended claims. This invention is especially applicable to use of a metadata envelope in conjunction with a service/content discovery system. Metadata is only one form of data, and delivery of metadata in files is only one form of delivery. This invention focuses on file download of metadata, although it will be clear that the same principles can be applied to file delivery in general, and in conjunction with streaming and potentially many other forms of delivery.

1. A method for transferring at least one data object (50) to a receiver (101), wherein said at least one data object is associated with a respective data envelope (51) that serves for at least one of identifying, versioning and time bounding said at least one data object, comprising:
embedding (110) said at least one data envelope and a representation of said at least one data object into a compound container object (52), and
transferring (112) said compound container object to said receiver.

2. The method according to claim 1, wherein said at least one data object (50) is a metadata object that represents a description of services and/or content that can be used by said receiver (101).

3. The method according to any of the claims 1-2, wherein said at least one data object (50) and said respective associated data envelope (51) form a data pair, and wherein at least two of said data pairs are embedded into said compound container object (52).

4. The method according to any of the claims 1-3, wherein said representation of said at least one data object (50) is said data object itself, or a reference to said data object.

5. The method according to any of the claims 1-4, further comprising:
determining (111) a compound container envelope (53) that serves for at least one of identifying, versioning and time bounding of said compound container object (52), and
transferring (112) said compound container envelope to said receiver (101).

6. The method according to any of the claims 1-5, wherein said compound container object (52) is versioned separately from said at least one data object (50) it contains.

7. The method according to any of the claims 5-6, wherein said time bounding of said compound container object (52) at least partially depends on said time bounding of said at least one data object (50) it contains.

8. The method according to any of the claims 5-7, wherein said compound container envelope (53) and said at least one data envelope (51) obey the same semantics and syntax.

9. The method according to any of the claims 1-8, wherein said compound container object (52) obeys the Multipart Multipurpose Internet Mail Extensions format.

10. The method according to any of the claims 1-9, wherein said compound container object (52′, 52″) is considered as a data object, and wherein a representation of said compound container object is embedded into a hierarchically superordinated compound container object (52).

11. The method according to any of the claims 1-10, wherein said compound container object (52) contains at least one object (55) that provides information on the structure of said compound container object and/or on the data objects (50) contained therein.

12. The method according to any of the claims 1-11, wherein said compound container object (52) is transferred (112) to said receiver (101) via the Hypertext Transfer Protocol and/or the File Delivery over Unidirectional Transport protocol.

13. The method according to any of the claims 1-12, wherein data envelopes and representations of data objects embedded into said compound container object (52) are transferred (112) to said receiver via different bearers and/or protocols.

14. The method according to any of the claims 1-12, wherein data envelopes and representations of data objects embedded into said compound container object (52) are transferred (112) to a first receiver via a first set of bearers and/or protocols, and wherein data envelopes and representations of data objects embedded into said compound container object (52) are transferred (112) to a second receiver via a second set of bearers and/or protocols.

15. A computer program with instructions operable to cause a processor to perform the method steps of any of the claims 1-14.

16. A computer program product comprising a computer program with instructions operable to cause a processor to perform the method steps of any of the claims 1-14.

17. A system (100, 101) for transferring (112) at least one data object (50) to a receiver (101), wherein said at least one data object is associated with a respective data envelope (51) that serves for at least one of identifying, versioning and time bounding said at least one data object, comprising:
means arranged for embedding (110) said at least one data envelope and a representation of said at least one data object into a compound container object (52), and
means arranged for transferring (112) said compound container object to said receiver.

18. A transmitter (100) for transferring (112) at least one data object (50) to a receiver (101), wherein said at least one data object is associated with a respective data envelope (51) that serves for at least one of identifying, versioning and time bounding said at least one data object, said transmitter comprising:
means arranged for embedding (110) said at least one data envelope and a representation of said at least one data object into a compound container object (52), and
means arranged for transferring (112) said compound container object to said receiver.

19. A receiver (101) for receiving at least one data object (50),
wherein said at least one data object is associated with a respective data envelope (51) that serves for at least one of identifying, versioning and time bounding said at least one data object, wherein said at least one data envelope and a representation of said at least one data object are embedded (110) into a compound container object (52), and wherein said compound container object is transferred (112) to said receiver by a transmitter (100), said receiver comprising:
means arranged for receiving said transferred compound container object, and
means arranged for extracting said at least one data envelope and said representation of said at least one data object from said received compound container object (52).

20. A method for transferring data objects (50) to a receiver (101) in a file carousel system (100, 101), wherein all data objects of a subset of data objects out of a plurality of data objects require to be associated so that a receiver knows to receive all data objects of said subset, comprising:
embedding respective representations of all data objects (50) of said subset into a compound container object (52), and
transferring said compound container object to said receiver.
